(19) United States
(12) Patent Application Publication
(10) Pub. No.: US 2024/0185733 A1
(43) Pub. Date: Jun. 6, 2024

(54) A COACHING AND SELF-ACCOUNTABILITY SYSTEM AND METHOD

(71) Applicant: Plexxis Software Inc., Brampton (CA)

(72) Inventor: Jason Fraser, Victoria (CA)

(21) Appl. No.: 18/525,951

(22) Filed: Dec. 1, 2023

Related U.S. Application Data
(60) Provisional application No. 63/385,801, filed on Dec. 2, 2022.

(51) Int. Cl. G09B 5/02; G06Q 10/0639

(52) U.S. Cl. CPC G09B 5/02; G06Q 10/06398

(57) ABSTRACT

Described are various embodiments of a self-accountability and coaching system and method. In one embodiment, the method comprises the steps of: defining, by a first user via a first user device, a list of task-related items, the list of task-related items comprising: a selection of one or more daily priorities to be performed, one or more suggested strategies for achieving at least one daily priority, and one or more milestones giving a sense of achievement; and notifying a second user via a second user device upon said defining being done and providing a time-of-the-day of said defining; generating a first set of one or more metrics based on the plurality of task-related items and the time-of-the-day; and transmitting via a network and displaying via a display of the second user device, to the second user, the plurality of task-related items of the first user and the one or more metrics.

### CROSS-REFERENCE TO RELATED APPLICATIONS

The application claims the benefit of U.S. Provisional Application No. 63/385,801 filed Dec. 2, 2022, which is incorporated herein by reference in its entirety.

### FIELD OF THE DISCLOSURE

The present disclosure relates to self-help and task monitoring systems and methods and, in particular, to a coaching and self-accountability system and method.

### BACKGROUND

There exists a large number of systems and platforms that provide productivity or task-monitoring features. However, most of these do not provide self-accountability tools. In a work setting environment, goals are often provided to workers from higher ranking employees or supervisors, which may be an impediment to good morale or motivation.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a coaching and self-accountability system and method that overcomes the deficiencies of existing solutions.

In accordance with a first aspect, there is provided a computer-implemented self-accountability method, comprising the steps of: recording, on a server, a first time-of-day upon which a first user accesses a corresponding first user account stored on the server via a first user device communicatively coupled to the server via a network; defining, on the first user device by the first user, a first list of task-related items comprising: a selection of one or more daily priorities to be performed by the first user; a selection of one or more suggested strategies for achieving at least one daily priority; a selection of one or more milestones giving a sense of achievement to the first user; and transmitting, from the first user device to the server, the first list of task-related items; generating, on the server, a first set of one or more metrics based on the plurality of task-related items and the first time-of-day; sending, from the server to the first user device, the one or more metrics; displaying, via a display of the first user device, said one or more metrics to said first user.

In one embodiment, the computer-implemented method further comprises the steps of: transmitting, from the server to a second user device of a second user, the second user device communicatively coupled to the server, the first list of task-related items of the first user and the one or more metrics; and displaying, on a display of the second user device, to the second user, the first list of task-related items of the first user and the first set of one or more metrics.

In one embodiment, the first set of one or more metrics include an attendance metric of the first user based on the first time-of-the-day.

In one embodiment, the computer-implemented method further comprises receiving, on the server from the first user device, an indication that one or more tasks of said selection of one or more daily priorities have been completed by the first user; and the first set of one or more metrics include a completion metric of the selection of one or more daily priorities.

In one embodiment, displaying on the display of the first user device and on the display of the second user device comprises presenting a calendar view, the calendar view visually illustrating for each day via one or more graphical elements said attendance metric and said completion metric.

In one embodiment, the computer-implemented method further comprises the step of: receiving, on the second user device from the second user, feedback related to at least one item of said first list of task-related items; transmitting, from the second user device to the server, said feedback; retrieving, from the server, on the first user device, said feedback; and displaying, on the display of the first user device, the feedback to the first user.

In one embodiment, the feedback comprises text or a rating indicator.

In one embodiment, the computer-implemented method further comprises the steps of: receiving, on the second user device from the second user, one or more expectations related to one or more scheduled tasks of the first user; transferring, from the second user device to the server, the one or more expectations; fetching, from the server on the first user device, the one or more expectations; and displaying, on the display of the first user device, the one or more expectations.

In one embodiment, the computer-implemented method further comprises the steps of: recording, on the server, a second time-of-day upon which the second user accesses a corresponding second user account via the second device; defining, on the second user device by the second user, a second list of task-related items comprising: a second selection of one or more daily priorities to be performed by the second user; a second selection of one or more suggested strategies for achieving at least one daily priority; a second selection of one or more milestones giving a sense of achievement to the second user; and transmitting, from the second user device to the server, the second list of task-related items; generating, on the server, a second set of one or more metrics based on the second list of task-related items and the second time-of-day; sending, from the server to the second user device, the one or more metrics; displaying, via the display of the second user device, said second set of one or more metrics to said second user.

In one embodiment, the computer-implemented method further comprises: transmitting, from the server to the first user device, the second list of task-related items of the second user and the second set of one or more metrics; and displaying, on the display of the first user device, to the first user, the second list of task-related items of the second user and the second set of one or more metrics.

In one embodiment, the computer-implemented method further comprises: transmitting, from the server to a third user device of a third user, the third user device communicatively coupled to the server via the network, the second list of task-related items of the second user and the second set of one or more metrics; and displaying, on the display of the third user device, to the third user, the second list of task-related items of the second user and the second set of one or more metrics.

In accordance with a second aspect, there is provided a self-accountability and coaching system, the system comprising: a server comprising one or more processors, the one or more processors operably coupled to a memory and a network adapter, the server communicatively coupled to a network via said network adapter; a first user device communicatively coupled to the server via a network, the first user device comprising a display; the server configured to: record a first time-of-day upon which a first user accesses a corresponding first user account on the server via the first user device; the first user device being further configured to: receive a first list of task-related items comprising: a selection of one or more daily priorities to be performed by the first user; a selection of one or more suggested strategies for achieving at least one daily priority; a selection of one or more milestones giving a sense of achievement to the first user; and transmit to the server the first list of task-related items; the server further being configured to: generate a first set of one or more metrics based on the plurality of task-related items and the first time-of-day; send to the first user device the one or more metrics; and the first user device further being configured to: display, via the display of the first user device, said one or more metrics to said first user.

In one embodiment, the system further comprises a second user device of a second user, the second user device communicatively coupled to the server; and the server is further configured to transmit to the second user device the first list of task-related items of the first user and the one or more metrics; and the second user device is configured to display, on a display of the second user device, to the second user, the first list of task-related items of the first user and the first set of one or more metrics.

In one embodiment, the first set of one or more metrics include an attendance metric of the first user based on the first time-of-the-day.

In one embodiment, the server is further configured to: receive from the first user device an indication that one or more tasks of said selection of one or more daily priorities have been completed by the first user; and the first set of one or more metrics include a completion metric of the selection of one or more daily priorities.

In one embodiment, the displaying on the display of the first user device and on the display of the second user device comprises presenting a calendar view, the calendar view visually illustrating for each day via one or more graphical elements said attendance metric and said completion metric.

In one embodiment, the second user device is further configured to: receive feedback from the second user related to at least one item of said first list of task-related items; and transmit to the server, said feedback; and the first user device is further configured to: retrieve, from the server said feedback; and display, on the display of the first user device, the feedback to the first user.

In one embodiment, the feedback comprises text or a rating indicator.

In one embodiment, the second device is further configured to: receive from the second user, one or more expectations related to one or more scheduled tasks of the first user; and transfer to the server, the one or more expectations; and the first user device is further configured to: fetch from the server the one or more expectations; and display on the display of the first user device the one or more expectations.

In one embodiment, the server is further configured to: record a second time-of-day upon which the second user accesses a corresponding second user account stored on the server via the second device; and the second user device is further configured to: receive from the second user a second list of task-related items comprising: a second selection of one or more daily priorities to be performed by the second user; a second selection of one or more suggested strategies for achieving at least one daily priority; a second selection of one or more milestones giving a sense of achievement to the second user; and transmit to the server the second list of task-related items; and the server further being configured to: generate a second set of one or more metrics based on the second list of task-related items and the second time-of-day; send to the second user device the one or more metrics; and the second user device further being configured to: display, via the display of the second user device, said second set of one or more metrics to said second user.

In one embodiment, the server is further configured to: transmit to the first user device, the second list of task-related items of the second user and the second set of one or more metrics; and the first user device is further configured to: display, on the display of the first user device, to the first user, the second list of task-related items of the second user and the second set of one or more metrics.

In one embodiment, the system further comprises a third user device of a third user, the third user device communicatively coupled to the server via the network, and the server is further configured to: transmit to the third user device the second list of task-related items of the second user and the second set of one or more metrics; and the third user device is configured to: display, on the display of the third user device, to the third user, the second list of task-related items of the second user and the second set of one or more metrics.

Other aspects, features, and/or advantages will become more apparent upon reading the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 is a schematic diagram of a coaching and self-accountability system, in accordance with one embodiment;

FIG. 2 is a schematic diagram of a server and a user device of the system of FIG. 1, in accordance with one embodiment;

FIG. 3 is a schematic diagram of a user profile which includes a contributor and reviewer role, in accordance with one embodiment;

FIG. 4 is a schematic diagram of a contributor platform, in accordance with one embodiment;

FIG. 5 is a schematic diagram illustrating exemplary task-related items, in accordance with one embodiment;

FIG. 6 is a schematic diagram illustrating an exemplary list of contributor-related metrics, in accordance with one embodiment;

FIG. 7 is a schematic diagram illustrating a reviewer platform, in accordance with one embodiment;

FIG. 8A and FIG. 8B are schematic diagrams illustrating different reviewing relationships between users, in accordance with one embodiment; and

FIG. 9, FIG. 10, FIG. 11, FIG. 12, FIG. 13 and FIG. 14 are photographs of an exemplary graphical user interface (GUI) of the system of FIG. 1, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to the details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The systems and methods described herein provide, in accordance with different embodiments, different examples of a coaching and self-accountability system and method. As will be detailed further below, some of the embodiments considered herein provide different tools to a single individual or to a plurality of individuals working together for self-assessing their work and productivity-related matters in a manner that allows each individual to gain or improve self-accountability. Using those tools, each user—or contributor (e.g., to a project or to a common, shared objective between a plurality of users) may journal a plurality of task-related items at the beginning of each day. They can select or choose which tasks to prioritize, which strategies or tactics they may want to use to achieve those tasks, and which objective or milestone gives them a sense of achievement that day.

In addition, some embodiments further gives some individuals or users the additional ability of monitoring, reviewing or coaching other contributors, by providing tools for giving feedback or for communicating expectations on those contributors, for example. This allows the user to “review” one or more contributors in a given group or organization. For example, in some embodiments, a reviewer may have access to view the tasks-related items of a given user, one or more metrics related to that user (such as an assiduity metric and a task completion metric or others) and further allows the reviewer to provide feedback. The reviewer role is not meant to provide directives, orders or tasks to the contributor, but only to provide feedback or expectations relating to that user. The user can then use that feedback or the knowledge of those expectations to decide which tasks should be prioritized, etc. However, it does allow the reviewer to identify bad trends in the performance or motivation of a user/collaborator.

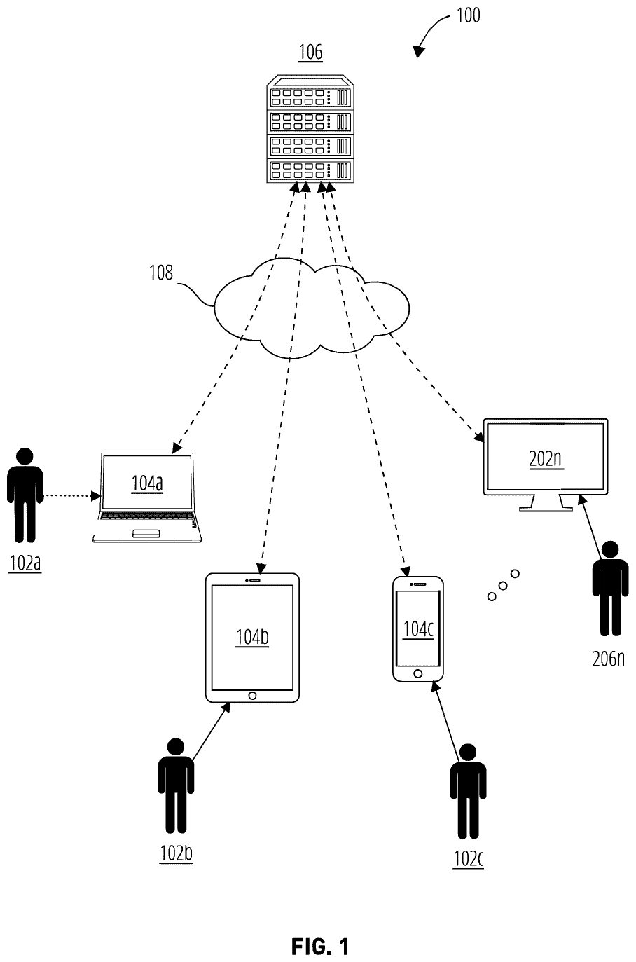

FIG. 1 shows a schematic diagram illustrating an exemplary system 100, in accordance with one embodiment. In this example, the system 100 is implemented as a cloud-based software-as-a-service (SaaS) platform or the like. A plurality of users 102a, 102b, 102c, . . . 102n may each use or interact with a corresponding user device 104a, 104b, 104c, . . . 104n to access the online platform and the tools provided thereby.

In some embodiments, the user-devices 104a-104n typically take the form of a dedicated computing or digital processing device, including for example, but not limited to, a desktop computer, a laptop computer, a tablet, a smartphone, a smartwatch or the like. The user devices 104a, 104b, 104c, . . . 104n are each communicatively coupled, directly or indirectly, to a server 106 via a network 108. Although a single server 106 is illustrated in FIG. 1, the skilled person in the art will appreciate that the server 106 may comprise a plurality of communicatively coupled servers or the like. In some other embodiments, the system 100 may allow partial or full offline functionality, and thus not require, or require in a limited fashion, the server 202.

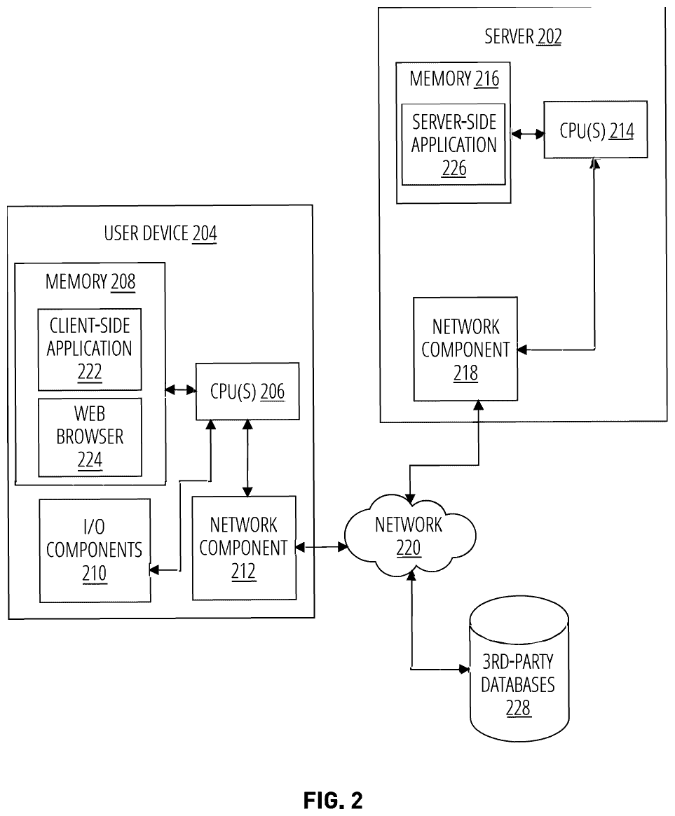

FIG. 2 is a schematic diagram illustrating an exemplary user device 204 and server 202, both of which are dedicated computing or digital processing devices. The user device 204 thus comprises one or more digital processors (e.g., CPU(s) 206), a memory 208, i/o components 210, and a network component 212. The server 202 similarly comprises one or more processors (e.g., CPU(s) 214), a memory 216 and a network component 218.

In some embodiments, the memories 208 and 216 may comprise any known form of computer memory or storage. This may include, for example, but without limitation, storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory, solid state memory or other memory technology, CDROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any method, application or module herein described may be implemented using computer readable/executable instructions that may be stored or otherwise held by such computer readable media and executed by the one or more processors.

In some embodiments, the CPU(s) 206 and 214 may include any known type of digital processor or the like. This can include general purpose processors (e.g., x86 or the like), embedded processors, or programmable processors (e.g., field programmable gate array processors or FPGA). Further, unless the context clearly indicates otherwise, any processor set out herein may be implemented as a singular processor or as a plurality of processors. The plurality of processors may be arrayed or distributed, and any processing function referred to herein may be carried out by one or by a plurality of processors, even though a single processor may be exemplified.

The network components 212 and 218 each may be operable or configured to enable the computer to communicate and/or exchange data with other components, to access and connect to network resources, to serve applications, and/or perform other computing applications by connecting to a network 220.

Network 220 can be a single network or multiple connected networks capable of carrying data, including the Internet, an Ethernet network, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

The input/output components (e.g., I/o components 210) of the user device 204 allow communication with a human user via an associated input, output, or input/output device such as a keyboard, a mouse, a touchscreen, and display. The display may be used to generate a graphical user interface (GUI) or the like.

As mentioned above, in some embodiments, the system may be configured using a client-server model or the like. The user device 204 may comprise a client-side application 222 in memory 208 which, upon being executed by the CPU(s) 206 allow the user device 204 to communicate with the server 202 via the network component 212. Other embodiments may have the user device 204 connecting to server 202 via a web browser 224 or the like. The server 202 may comprise in the memory 216 a server-side application 226 that allows the CPU(s) 214 to respond to or communicate with the user device 204 via the network component 218. Different tools or features described herein may be implemented via applications 222/226 in different ways. The skilled person in the art will appreciate that different modules/instructions may be combined or distributed on different devices, in accordance with different implementations.

In some embodiments, the server 202 and/or user device 204 may further be configured to communicate with one or more 3rd-party databases 228 via network 220. This may include, for example, one or more 3rd-party servers or databases relating to different services, for example email servers, scheduling systems, or the like.

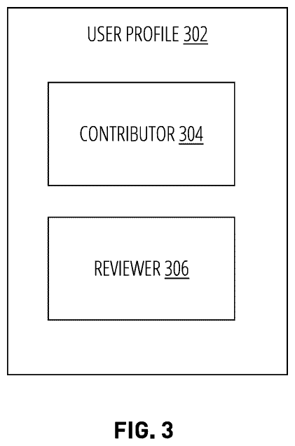

FIG. 3 is a schematic diagram illustrating a user profile 302 comprising two non-exclusive roles: as a contributor 304 and as a reviewer 306. As mentioned above, any user is typically included as a contributor 304 and thus has access to the contributor's features and tools for communicating and self-assessing their own performance and motivation. In addition, some users may further be defined as reviewers 306. In addition to the contributor 304 features, they also have access to additional tools that allow them to monitor or coach one or more contributors 304.

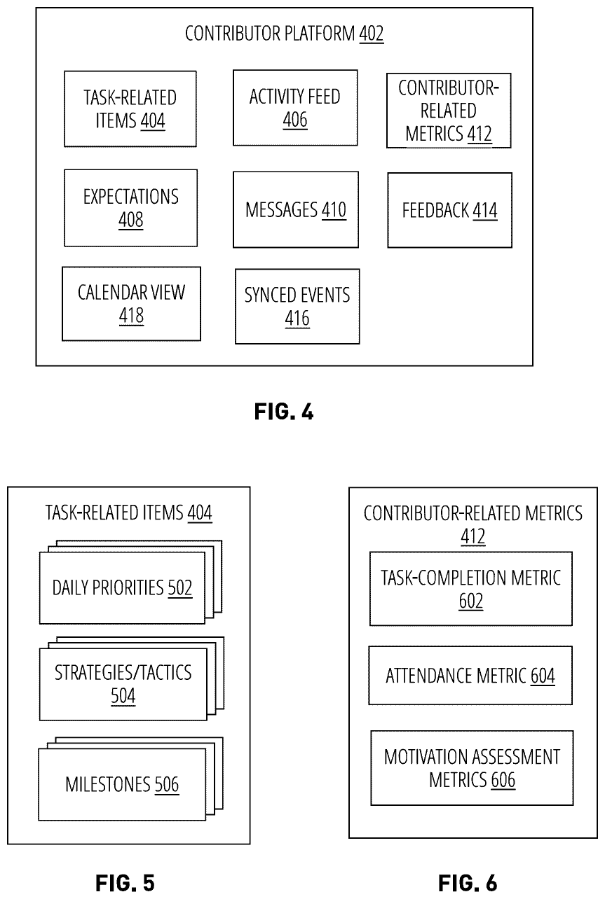

FIG. 4 shows a schematic diagram illustrating different features/tools provided to a contributor 304. The contributor has access to a contributor platform 402 that can be used for self-journaling, task assessment and self-accountability. Examples of features provided to contributors 304 include, in some embodiments, the ability to define and select a plurality of task-related items 404, an activity feed 406 showing a list of tasks-related activities, a list of expectations 408 placed on the user by reviewers 306 and/or other collaborators, a messaging feature 410 for communicating with other collaborators, a plurality of contributor-related metrics 412 computed based on the actions of the contributor, feedback 414 received from reviewers, synced events or items 416 (e.g., from 3rd-party databases—email servers, scheduling applications, etc.), and a calendar view 418 illustrating via graphical representations the performance and/Or assiduity of the contributor.

FIG. 5 is a schematic diagram illustrating an exemplary list of task-related items 404 that a contributor 304 may add to the platform and select. These may include, for example, a list of daily priorities 502 (e.g., tasks to be accomplished), a selection of strategies/tactics 504 that may be used to accomplish at least some of those tasks, and one or more milestones or goals that the contributor feels give him or her a sense of accomplishment. In some embodiments, each item is first entered by the user and recorded by the system. Then, each day, the user may select (via a selection box or similar) one or more of these items for the current day.

FIG. 6 is a schematic diagram illustrating examples of contributor-related metrics 412, in accordance with one embodiment. These may include task-completion metrics 602 related to how many selected daily priorities 502 have been fulfilled, and an attendance metric 604 cataloguing a time-of-day at which the contributor first uses the system 100 on each day. Other metrics may be generated or provided, such as a plurality of motivation assessment metrics 606 based for example on a combination of the attendance metric 604 and task-completion metric 602.

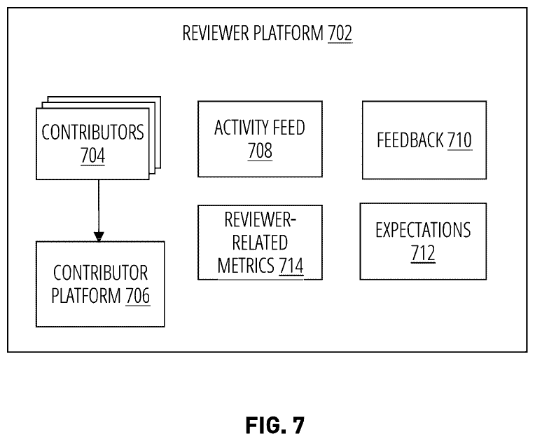

FIG. 7 is a schematic diagram illustrating an example of a reviewer platform 702 which is accessible by a reviewer 306, in accordance with one embodiment. In this example, the reviewer platform 702 may comprise a list of contributors 704 that the reviewer is currently allowed to coach or review. For each contributor 704, data from the contributor platform 706 of that contributor is viewable in full by the reviewer 306. This includes viewing the list of task-related items 404, and which item has been selected for a given day. It further comprises its own activity feed 708 relating to review-related events. To allow the reviewer to coach the contributor, an ability to send or give feedback 710 to a given contributor 704 is provided. This may include providing textual messages in the form of reflections that imparts tips or comments regarding each item. It can also include providing a rating for a given item, for example whether it is a good or bad idea—via a graphical item or emoji. Furthermore, the ability to create and send written notes of expectations 712 the reviewer has on the contributor 704 is also provided. This may include tagging the target contributor, for example using the @ and the username of the contributor. The contributor in question will be notified of the expectation placed upon him by the reviewer.

In some embodiments, the platform 702 may also generate a plurality of reviewer-related metrics 714. These may include, for example, a performance rating of the coaching effectiveness of the reviewer based on correlations between the actions of the reviewer and a change in performance of the contributor. In other examples, it may provide an indication of how often the reviewer actually reviews the contributor, and thus whether the reviewer is working as intended.

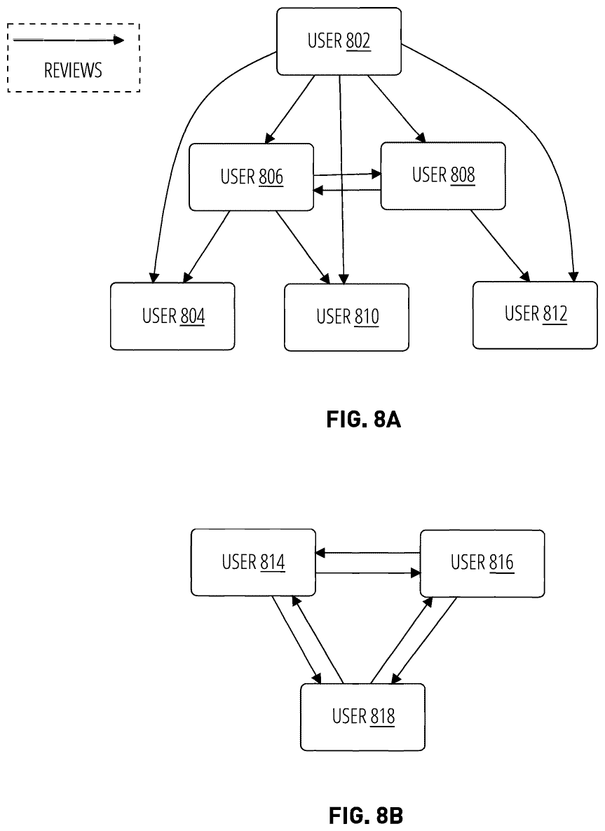

FIGS. 8A and 8B are schematic diagrams illustrating examples of reviewer-collaborator and/or reviewer-reviewer relationships that can be set-up, in accordance with one embodiment. Typically, all users can be contributors 304, but any user can also become a reviewer 306 and have access to the coaching and reviewing features. In addition, any reviewer 306 can also, if desired, be reviewed or coached by another reviewer. FIG. 8A shows, as an example only, a group of users 802-812 using the system 100 to collaborate. The arrows indicate a review relationship (pointing from a reviewer to a user being reviewed by that reviewer). In this example, user 802 is a “master reviewer” and has the ability to review all the other users (e.g., users 806, 808, 804, 810 and 812). Users 806 and 808, meanwhile, have the ability to review each other in addition to users 804, 810 and 812. Finally, users 804, 810 and 812 are only contributors 304 and do not have access to the reviewing functions. This example may correspond to a more hieratical leadership organization, whereas the user 802 is an upper management administrator, users 806 and 808 are middle management administrators and users 804, 810 and 812 are employees.

In contrast, FIG. 8B shows another example where the users are organized as a community of reviewers. Thus, in this example, users 814, 816 and 818 are both collaborators but also reviewers of each other. Other examples may combine the examples of FIGS. 8A and 8B, wherein sub-groups of users are organized as communities of reviewers, but whereas all the users in a sub-group can be reviewed by another sub-group, etc. The skilled person in the art will appreciate the flexibility offered by the platform and thus that any type of relationship, reciprocal or not, may be configured by a group of users to best suit their organizational needs.

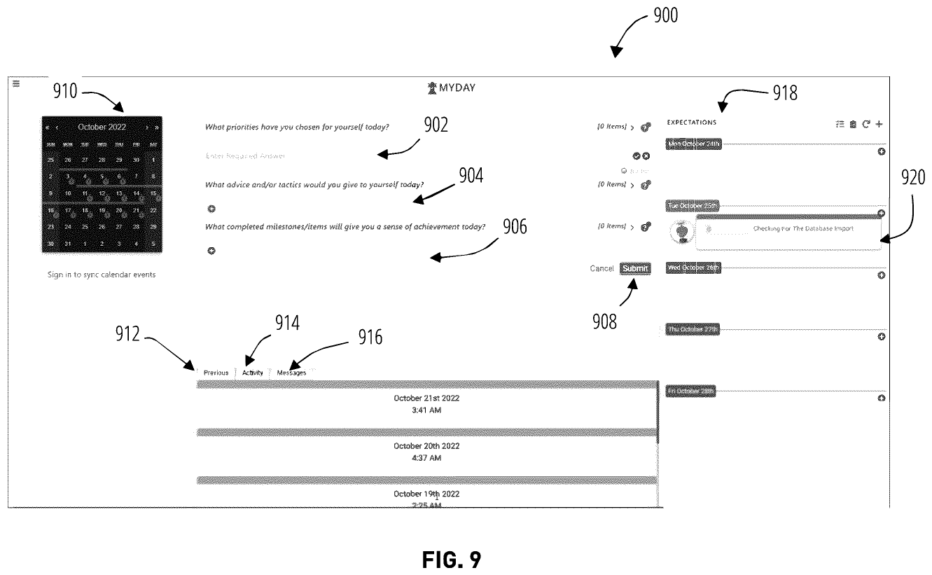

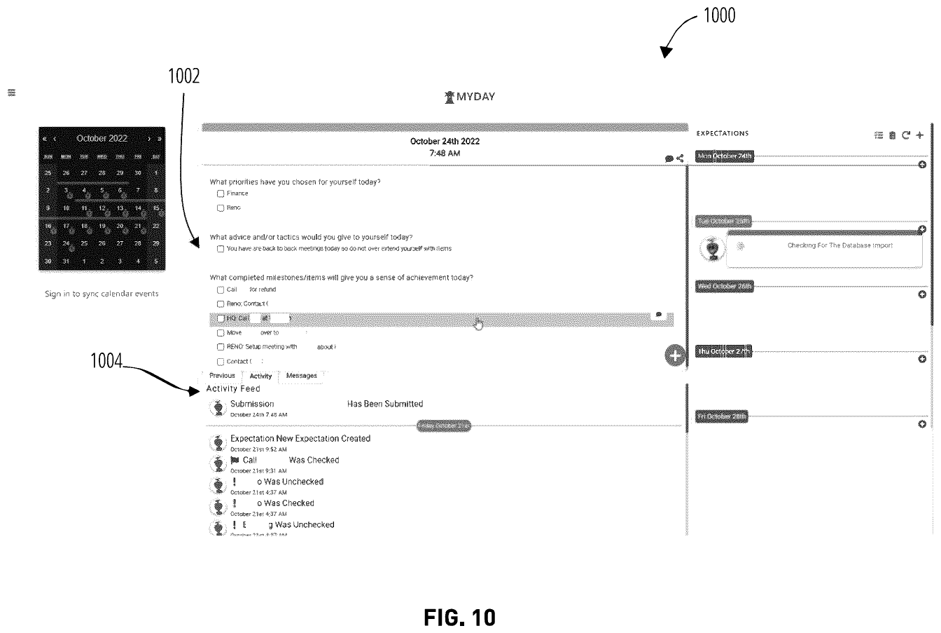

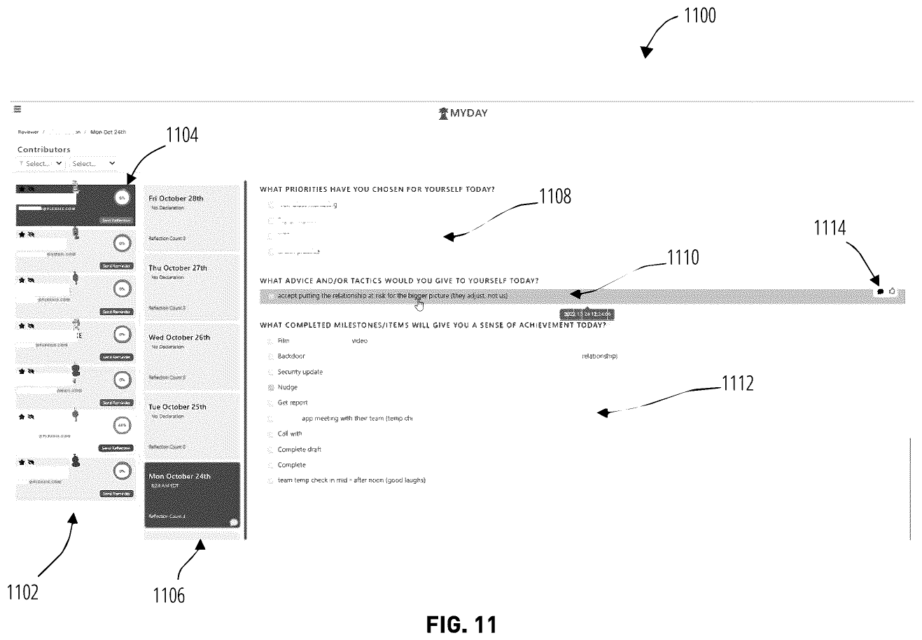

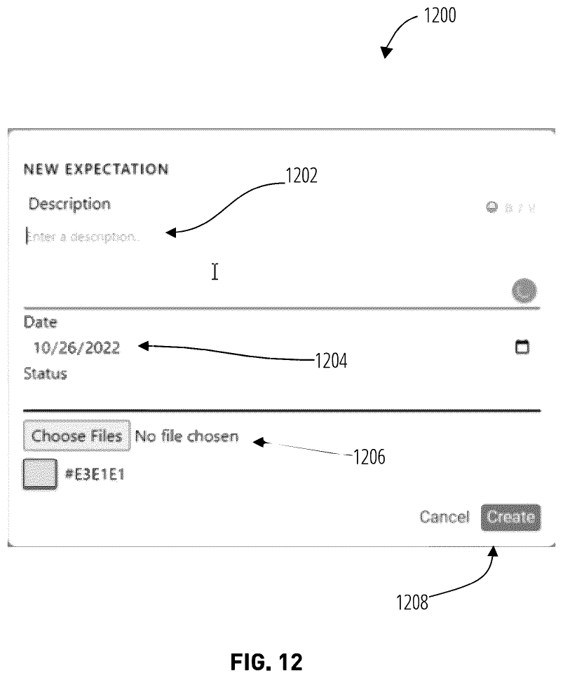

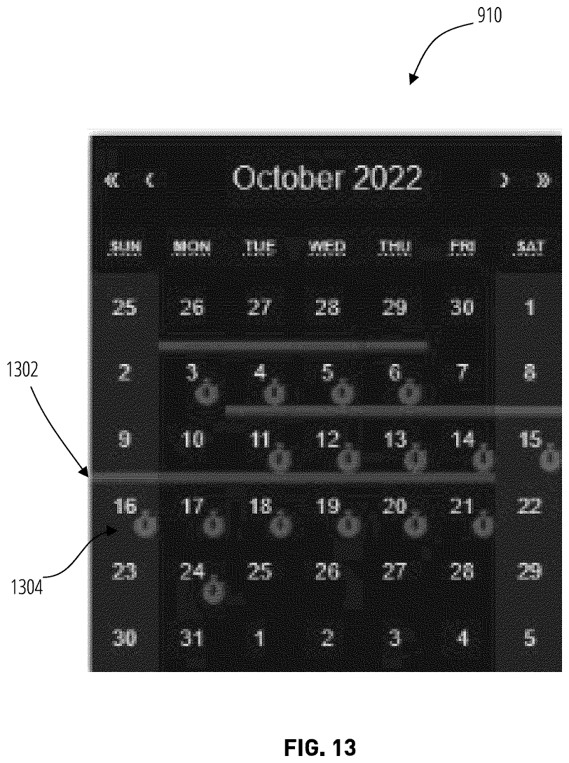

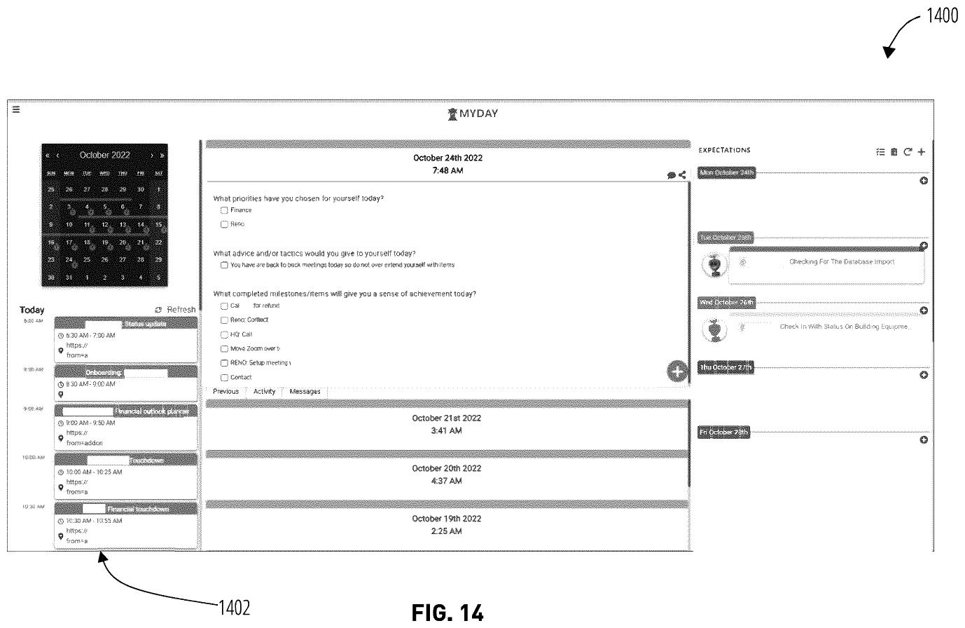

FIGS. 9 to 14 are photographs of an exemplary graphical user interface (GUI) provided by the system 100 to a user. FIG. 9 shows a home screen 900 of for a new user acting as a collaborator. In this example, the new user doesn't have any items entered, hence the middle portion can be used enter or type any number of task-related items 404. The user may enter these by typing in the fields 902, 904 and 906 to add one or more daily priorities 502, strategies/tactics 504 or milestones 506, respectively. Once entered, a submit button 908 may be selected to record the new items. On the left hand side is a monthly calendar 910 illustrating the days of the current month having proximate thereto graphical indicators showing a completion metric and an assiduity metric. At the bottom center, a selection of past 912 or current 914 recorded activities can be displayed, or a list messages 916. On the left-hand side, a dated list of expectations 918 that have been put upon the user by one or more reviewers (for example expectation 920) are displayed.

As shown in FIG. 10, once the list of task-related items 404 have been entered (at least once), the middle portion 1002 of the screen 1000 takes the form of a selectable listing of items. Each day, a user can select (via the selection boxes or similar) which item(s) 502, 504 or 506 the user is choosing and/or planning on executing that day. These are recorded and viewable by a reviewer coaching or reviewing the user. In addition, the time-of-day the user first logs in or uses the platform is recorded and used to calculate the attendance metric 604. Also shown in FIG. 10 is the activity feed 1004 at the bottom wherein a plurality of events are shown in order of occurrence. This can include whether an item box was checked or unchecked, whether a new expectation was created, but may also include any platform-related event pertinent to the user.

FIG. 11 is a photograph of an exemplary GUI screen 1100 presented to a user having reviewing access to a plurality of collaborating users. On this screen, on the left hand side, a list of collaborators 1102 is shown. The list can be filtered or customized. Typically, the list includes enough information to identify the collaborator and a performance indicator. In this example, it includes the names, email addresses and a completion metric 1104. The reviewer can easily look and see the overall performance of each collaborator. Upon selecting one collaborator, a list of calendar days 1106 is shown, each day of which can be selected by the reviewer to view the selections 1108, 1110 and 1112 made by collaborator for that day. In this example, when the reviewer selects an item from the list, a plurality of feedback options 1114 are shown on the right-hand side. This may include entering a written feedback message or providing a rating—for example by selecting a motivational or approval icon (e.g., a thumbs-up icon in this case) that will be sent to the collaborator. In addition, the list 1106 also shows a count of reflections or written feedback provided by the reviewer for each day.

FIG. 12 shows an exemplary new expectation window 1200 which is used when a reviewer enters a new expectation to be placed upon a collaborator. A new expectation typically comprises a description 1202, a date 1204 and one or more files that are to be joined or attached via a menu 1206 to the expectation message. A create button 1208 is selected to finalize the process.

FIG. 13 shows a close-up of the exemplary calendar 910 discussed above. Below each day, graphical indicators as also displayed to convey metric-related information about that collaborator. For example, a colored bar indicator (for example bar indicator 1302) is presented, the color of which is indicative of the task-completion metric 602. In one example, the color may change between green to red to indicate a good or bad indicator, respectively. In addition, colored clock icon or representation 1304 is shown to visually indicate the attendance metric 604 for that day. Thus, the collaborator can quickly at a glance self-assess, or any reviewer can assess, the performance of that collaborator. This allows trends of bad or good performance to be identified as a function of time.

FIG. 14 shows another view 1400, similar to the view 1000 of FIG. 10, but wherein in addition a listing 1402 of scheduled tasks, meetings or engagements imported from one or more 3rd-party databases 228 is shown. This may include, for example, importing schedules from scheduling applications or services, and/or extracting engagements from third-party email servers, etc. This may include, without limitation, data from services such as Outlook™, Jira™, Gmail™, or the like. This allows a user to view all of his or her engagements in a “master list” in one place.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A computer-implemented self-accountability method, comprising the steps of:
recording, on a server, a first time-of-day upon which a first user accesses a corresponding first user account stored on the server via a first user device communicatively coupled to the server via a network;
defining, on the first user device by the first user, a first list of task-related items comprising:
a selection of one or more daily priorities to be performed by the first user;
a selection of one or more suggested strategies for achieving at least one daily priority;
a selection of one or more milestones giving a sense of achievement to the first user; and
transmitting, from the first user device to the server, the first list of task-related items;
generating, on the server, a first set of one or more metrics based on the plurality of task-related items and the first time-of-day;
sending, from the server to the first user device, the one or more metrics;
displaying, via a display of the first user device, said one or more metrics to said first user.

2. The computer-implemented method of claim 1, further comprising the steps of:
transmitting, from the server to a second user device of a second user, the second user device communicatively coupled to the server, the first list of task-related items of the first user and the one or more metrics; and
displaying, on a display of the second user device, to the second user, the first list of task-related items of the first user and the first set of one or more metrics.

3. The computer-implemented method of claim 1, wherein said first set of one or more metrics include an attendance metric of the first user based on the first time-of-the-day.

4. The computer-implemented method of claim 3, further comprising:
receiving, on the server from the first user device, an indication that one or more tasks of said selection of one or more daily priorities have been completed by the first user; and
wherein said first set of one or more metrics include a completion metric of the selection of one or more daily priorities.

5. The computer-implemented method of claim 4, wherein said displaying on the display of the first user device and on the display of the second user device comprises presenting a calendar view, the calendar view visually illustrating for each day via one or more graphical elements said attendance metric and said completion metric.

6. The computer-implemented method of claim 2, further comprising the step of:
receiving, on the second user device from the second user, feedback related to at least one item of said first list of task-related items;
transmitting, from the second user device to the server, said feedback;
retrieving, from the server, on the first user device, said feedback; and
displaying, on the display of the first user device, the feedback to the first user.

7. The computer-implemented method of claim 6, wherein said feedback comprises text or a rating indicator.

8. The computer-implemented method of claim 2, further comprising the steps of:
receiving, on the second user device from the second user, one or more expectations related to one or more scheduled tasks of the first user;
transferring, from the second user device to the server, the one or more expectations;
fetching, from the server on the first user device, the one or more expectations; and
displaying, on the display of the first user device, the one or more expectations.

9. The computer-implemented method of claim 2, further comprising the steps of:
recording, on the server, a second time-of-day upon which the second user accesses a corresponding second user account via the second device;
defining, on the second user device by the second user, a second list of task-related items comprising:
a second selection of one or more daily priorities to be performed by the second user;
a second selection of one or more suggested strategies for achieving at least one daily priority;
a second selection of one or more milestones giving a sense of achievement to the second user; and
transmitting, from the second user device to the server, the second list of task-related items;
generating, on the server, a second set of one or more metrics based on the second list of task-related items and the second time-of-day;
sending, from the server to the second user device, the one or more metrics;
displaying, via the display of the second user device, said second set of one or more metrics to said second user.

10. The computer-implemented method of claim 9, further comprising:
transmitting, from the server to the first user device, the second list of task-related items of the second user and the second set of one or more metrics; and
displaying, on the display of the first user device, to the first user, the second list of task-related items of the second user and the second set of one or more metrics.

11. The computer-implemented method of claim 9, further comprising:
transmitting, from the server to a third user device of a third user, the third user device communicatively coupled to the server via the network, the second list of task-related items of the second user and the second set of one or more metrics; and
displaying, on the display of the third user device, to the third user, the second list of task-related items of the second user and the second set of one or more metrics.

12. A self-accountability and coaching system, the system comprising:
a server comprising one or more processors, the one or more processors operably coupled to a memory and a network adapter, the server communicatively coupled to a network via said network adapter;
a first user device communicatively coupled to the server via a network, the first user device comprising a display;
the server configured to:
record a first time-of-day upon which a first user accesses a corresponding first user account on the server via the first user device;
the first user device being further configured to:
receive a first list of task-related items comprising:
a selection of one or more daily priorities to be performed by the first user;
a selection of one or more suggested strategies for achieving at least one daily priority;
a selection of one or more milestones giving a sense of achievement to the first user; and
transmit to the server the first list of task-related items;
the server further being configured to:
generate a first set of one or more metrics based on the plurality of task-related items and the first time-of-day;
send to the first user device the one or more metrics; and
the first user device further being configured to:
display, via the display of the first user device, said one or more metrics to said first user.

13. The system of claim 12, further comprising a second user device of a second user, the second user device communicatively coupled to the server; and
wherein the server is further configured to transmit to the second user device the first list of task-related items of the first user and the one or more metrics; and
the second user device is configured to display, on a display of the second user device, to the second user, the first list of task-related items of the first user and the first set of one or more metrics.

14. The system of claim 13, wherein said first set of one or more metrics include an attendance metric of the first user based on the first time-of-the-day.

15. The system of claim 14, wherein the server is further configured to:
receive from the first user device an indication that one or more tasks of said selection of one or more daily priorities have been completed by the first user; and
wherein said first set of one or more metrics include a completion metric of the selection of one or more daily priorities.

16. The system of claim 15, wherein said displaying on the display of the first user device and on the display of the second user device comprises presenting a calendar view, the calendar view visually illustrating for each day via one or more graphical elements said attendance metric and said completion metric.

17. The system of claim 13, wherein the second user device is further configured to:
receive feedback from the second user related to at least one item of said first list of task-related items; and
transmit to the server, said feedback; and
wherein the first user device is further configured to:
retrieve, from the server said feedback; and
display, on the display of the first user device, the feedback to the first user.

18. The system of claim 17, wherein said feedback comprises text or a rating indicator.

19. The system of claim 13, wherein the second device is further configured to:
receive from the second user, one or more expectations related to one or more scheduled tasks of the first user; and
transfer to the server, the one or more expectations; and
wherein the first user device is further configured to:
fetch from the server the one or more expectations; and
display on the display of the first user device the one or more expectations.

20. The system of claim 13, wherein the server is further configured to:
record a second time-of-day upon which the second user accesses a corresponding second user account stored on the server via the second device; and
wherein the second user device is further configured to:
receive from the second user a second list of task-related items comprising:
a second selection of one or more daily priorities to be performed by the second user;
a second selection of one or more suggested strategies for achieving at least one daily priority;
a second selection of one or more milestones giving a sense of achievement to the second user; and
transmit to the server the second list of task-related items; and
the server further being configured to:
generate a second set of one or more metrics based on the second list of task-related items and the second time-of-day;
send to the second user device the one or more metrics; and
the second user device further being configured to:
display, via the display of the second user device, said second set of one or more metrics to said second user.
